(19) United States
(12) Patent Application Publication
(10) Pub. No.: US 2024/0423310 A1
(43) Pub. Date: Dec. 26, 2024

(54) Hard Hat with AR/VR Goggles

(71) Applicant: Milwaukee Electric Tool Corporation, Brookfield, WI (US)

(72) Inventors: Samuel L. Lombardi, Milwaukee, WI (US); Caleb C. Adams, Milwaukee, WI (US)

(21) Appl. No.: 18/762,022

(22) Filed: Jul. 2, 2024

Related U.S. Application Data
(63) Continuation of application No. PCT/US24/35075, filed on Jun. 21, 2024.
(60) Provisional application No. 63/556,993, filed on Feb. 23, 2024.
(60) Provisional application No. 63/617,200, filed on Jan. 3, 2024.
(60) Provisional application No. 63/509,921, filed on Jun. 23, 2023.

(51) Int. Cl. A42B 3/04

(52) U.S. Cl. CPC A42B 3/0406

(57) ABSTRACT

A hard hat configured to support an AR/VR headset or goggles and associated components is provided. The hard hat does not include a front brim allowing for appropriate positioning of the AR/VR goggles relative to the hard hat. A hinged bracket is coupled to the hard hat and the AR/VR goggles to allow for movement of the AR/VR goggles. The AR/VR goggles are moveable between an in use position in which the goggles are positioned in front of a user's face and a storage position in which the goggles are positioned above or away from the user's face.

### CROSS-REFERENCE TO RELATED PATENT APPLICATIONS

The present application is a continuation of International Application No. PCT/US2024/035075 filed Jun. 21, 2024, which claims the benefit of and priority to U.S. Provisional Application No. 63/556,993 filed on Feb. 23, 2024, to U.S. Provisional Application No. 63/617,200 filed on Jan. 3, 2024, and U.S. Provisional Application No. 63/509,921 filed on Jun. 23, 2023, which are incorporated herein by reference in their entireties.

### BACKGROUND OF THE INVENTION

The present invention relates generally to the field of protective helmets or hard hats. The present invention relates specifically to a protective helmet configured to support augmented reality/virtual reality (AR/VR) headset or googles and associated components.

### SUMMARY OF THE INVENTION

One embodiment of the invention relates to a safety headwear system. The safety headwear system includes a hard hat having an outer shell. The outer shell includes an exterior surface and an interior surface defining a cavity sized to receive a head of an operator. The outer shell further includes a crown portion that is configured to cover part of the head of the operator. A bottom portion defines a lower circumference along the exterior surface of the outer shell. The hard hat further includes side mounting ridges positioned on opposing lateral sides of outer shell along the bottom portion. The safety system further includes a mounting bracket. The mounting bracket includes a bracket arm having opposing ends. Each of the opposing ends of the bracket arm include a hinge configured to engage the side mounting ridges of the hard hat. The mounting bracket is configured to support a pair of AR/VR goggles.

Another embodiment of the invention relates to a mounting bracket for AR/VR goggles. The mounting bracket includes a bracket arm having a first end and a second end opposing the first end. The first end and the second end each include a hinge. The mounting bracket further includes a tilting mounting hinge positioned on the bracket arm between the first end and the second end. The tilting mounting hinge includes a front engagement portion configured to couple to AR/VR goggles.

Another embodiment of the invention relates to a safety headwear system. The safety headwear system includes a hard hat having an outer shell. The outer shell includes an exterior surface and an interior surface defining a cavity sized to receive a head of an operator. The outer shell further includes a crown portion having a front side and a rear side. The crown portion is configured to cover part of the head of the operator. A bottom portion defines a lower circumference along the exterior surface of the outer shell. The hard hat further includes a front mounting ridge positioned on the front side of the outer shell and side mounting ridges positioned on opposing lateral sides of the bottom portion. The safety headwear system further includes a mounting bracket that removably couples to the hard hat. The mounting bracket includes a first end and a second end that opposes the first end. The first end and the second end each include a hinge. The mounting bracket is configured to support a pair of AR/VR goggles such that the AR/VR goggles are moveable relative to the hard hat between an active position and a storage position.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a front perspective view of a hard hat supporting AR/VR goggles on the head of a wearer, according to an exemplary embodiment.

FIG. 2 is a rear perspective view of a hard hat of FIG. 1 supporting AR/VR goggles on the head of the wearer, according to an exemplary embodiment.

FIG. 3 is a front perspective view of the hard hat of FIG. 1, according to an exemplary embodiment.

FIG. 4 is a side view of the hard hat of FIG. 1, according to an exemplary embodiment.

FIG. 5 is a side view of a hard hat of FIG. 1 supporting AR/VR goggles in a first, active position, according to an exemplary embodiment.

FIG. 6 is a side view of a hard hat of FIG. 1 supporting AR/VR goggles in a second, storage position, according to an exemplary embodiment.

FIG. 7 is a cross-sectional view of the hard hat taken along line 7-7 of FIG. 5, according to an exemplary embodiment.

FIG. 8 is a front perspective view of a hinged bracket arm and AR/VR goggles, according to an exemplary embodiment.

FIG. 9 is a cross-sectional view of the hard hat and hinged bracket arm, according to an exemplary embodiment.

FIG. 10 is a rear perspective view of the hinged bracket arm and AR/VR goggle, according to an exemplary embodiment.

FIG. 11 is a front perspective view of the hinged bracket arm, according to an exemplary embodiment.

FIG. 12 is an exploded view of the hinged bracket arm of FIG. 11, according to an exemplary embodiment.

FIG. 13 is a perspective view of the hinge assembly and the AR/VR goggles, according to an exemplary embodiment.

FIG. 14 is a front perspective view of the hinge assembly, according to an exemplary embodiment.

FIG. 15 is an exploded view of the hinge assembly of FIG. 14 according to an exemplary embodiment.

FIG. 16 is a side view of the tilting mounting hinge, according to an exemplary embodiment.

FIG. 17 is a front perspective view of a mounting clip, according to an exemplary embodiment.

FIG. 18 is a rear perspective view of the mounting clip of FIG. 17, according to an exemplary embodiment.

FIG. 19 front perspective view of a hard hat supporting AR/VR goggles on the head of a wearer, according to another exemplary embodiment.

FIG. 20 is a side view of a hard hat of FIG. 19 supporting AR/VR goggles in a first, active position, according to an exemplary embodiment.

FIG. 21 is a side view of a hard hat of FIG. 19 supporting AR/VR goggles in a second, storage position, according to an exemplary embodiment.

FIG. 22 is an exploded view of the hard hat of FIG. 19 and the AR/VR goggles and associated components, according to an exemplary embodiment.

FIG. 23 is a side perspective view of a hard hat supporting AR/VR goggles on the head of a wearer, according to another exemplary embodiment.

FIG. 24 is a perspective view of a hard hat supporting AR/VR goggles on the head of a wearer, according to another exemplary embodiment.

FIG. 25 is a front perspective view of a portion of the hard hat of FIG. 24, according to an exemplary embodiment.

FIG. 26 is a side view of a portion of the hard hat of FIG. 24 according to an exemplary embodiment.

FIG. 27 is a front perspective view of a hinged bracket arm and AR/VR goggles, according to another exemplary embodiment.

FIG. 28 is an exploded view of a hinged bracket arm, according to another exemplary embodiment.

FIG. 29 is a side view of a hard hat supporting AR/VR goggles and accessories on the head of a wearer, according to another exemplary embodiment.

FIG. 30 is a side view of the hard hat of FIG. 29 supporting an accessory bracket, according to an exemplary embodiment.

FIG. 31 is a side view of the hard hat of FIG. 29 supporting an accessory bracket and a sun shade, according to an exemplary embodiment.

FIG. 32 is a perspective view of the accessory bracket, according to an exemplary embodiment.

### DETAILED DESCRIPTION

Referring generally to the figures, various embodiments of the hard hat or protective helmet discussed herein include various designs and materials that provide protection from impacts (e.g., falling objects, lateral impact of objects, impact from tripping/falling) and provide additional functionality through engagement with accessories. These hard hats are believed to reduce the risk and/or likelihood of head injuries (i.e., concussions, traumatic brain injuries, skull fractures, cuts, bruises, etc.) of the type that may be suffered by a worker on a jobsite while providing engagement with accessories such as AR/VR goggles that can provide information (e.g., access blueprints, material list, protocols, etc.) in a hands free manner. As will be generally understood, many conventional hard hats are designed to provide impact protection for specific portions of the head during specific types of impacts. For example, ANSI Type I hard hats protect the top of the head, and ANSI Type II hard hats are designed to provide top and side impact protection.

Referring generally to the figures, various embodiments of a hard hat or protective helmet configured to support an AR/VR headset or goggles (e.g., Microsoft Hololens 2) and associated components (e.g., battery packing, wiring, etc.) are shown. The hard hat is designed to support the AR/VR goggles and associated components while maintaining the protection functionality of the hard hat and providing a balanced, comfortable and easy to wear AR/VR equipped hard hat. In specific embodiments, the hard hat is an ANSI Type II hard hat. In specific embodiments, the hard hat does not include a front brim allowing for appropriate positioning of the AR/VR goggles between the in use/active and storage positions. Specifically, Applicant believes that removal of the brim allows for positioning of the AR/VR goggles at the appropriate spacing relative to the user's eyes when in use.

In specific embodiments, the hard hat includes a hinged bracket arm with opposing ends that engage opposing side mounting ports located on the lateral sides of the hard hat. Applicant believes that this hinged bracket arm design provides for tilting of the AR/VR goggles to a storage position that is relatively close to the outer surface of the hard hat. In this position, the hard hat remains balanced and comfortable to wear, while limiting the chance that the goggles impact or snag on the environment surrounding the user. Further, Applicant believes that by attaching the hinged bracket arm to side mounting ports of the hard hat better balance is provided, particularly compared to a front mount pivoting support.

In specific embodiments, a tilting mounting hinge is coupled to the center of the hinged bracket arm. The tilting mounting hinge includes a front engagement portion that couples to a pair of AR/VR goggles. The combination of the tilting mounting hinge and the side mounted hinged bracket arm are believed to provide for proper positioning of the AR/VR goggles, while still maintaining the protection functionality of the hard hat and providing a balanced and comfortable to wear hard hat equipped with AR/VR goggles.

In various embodiments, a front portion of the helmet is reduced in size. In other words, the distance the helmet extends outward relative to a user's head is decreased relative to conventional hard hats and/or helmets. In various specific embodiments, the size and/or outward extension of a front mounting ridge of the hard hat is reduced.

In specific embodiments, the AR/VR goggles are mounted or secured to a bracket arm such that a tilting mounting hinge is not required. Applicant has found such embodiments save space because there are a reduced number of structures (e.g., no mounting hinge) between the AR/VR goggles and the helmet. Applicant believes the AR/VR mounting structure described herein allows for the AR/VR goggles to be positioned closer to a desired or correct viewing position.

In specific embodiments, an accessory bracket is configured to support to couple to an accessory (e.g., battery pack, etc.) utilized with the AR/VR goggles in a higher position relative to a bottom segment of the helmet and/or a rear mounting ridge. Applicant has found the higher position of the accessory allows a user to simultaneously mount a sun visor and/or shade to the helmet for use with the AR/VR goggles. Applicant believes the ability to simultaneously support and use AR/VR googles and a sun visor reduces glare and improves the visibility and accuracy of the digital information or hologram produced by the AR/VR goggles.

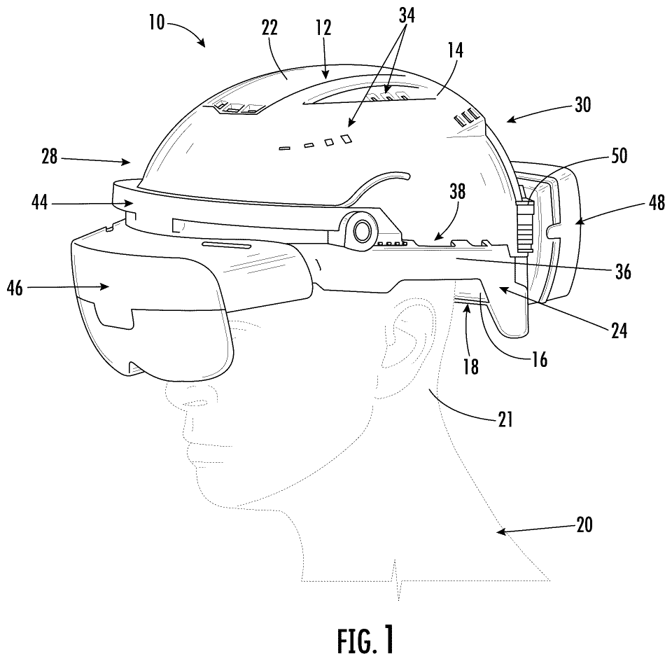

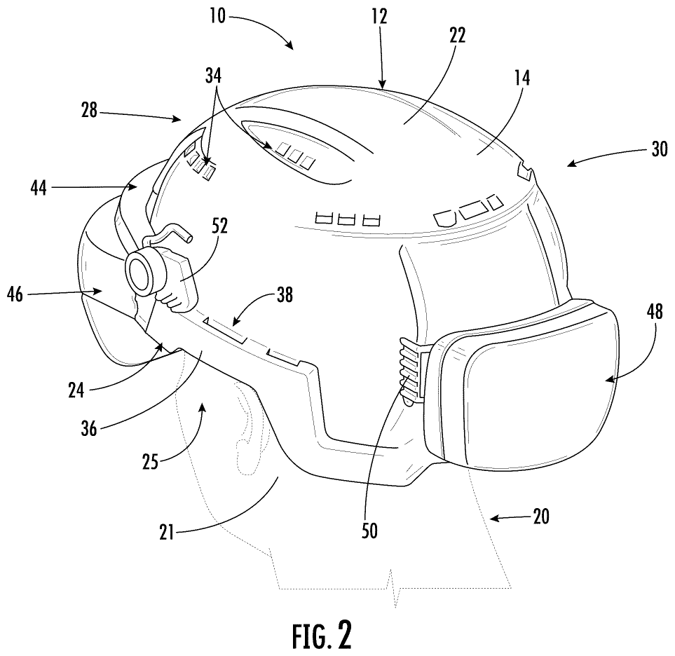

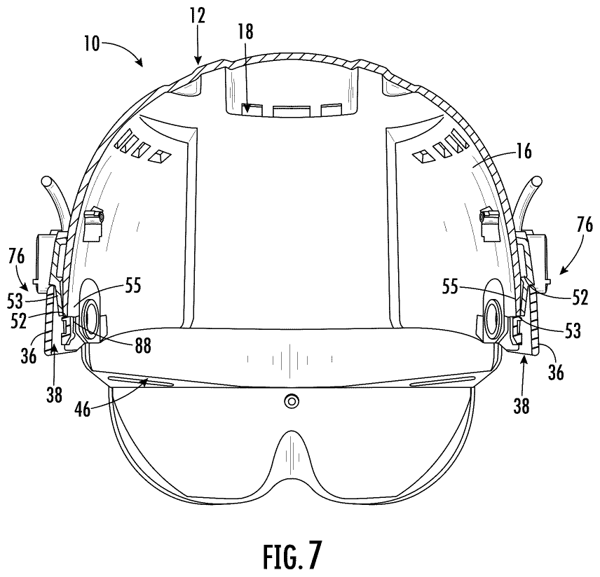

Referring to FIGS. 1-2, perspective views of a protective work or construction helmet, shown as hard hat 10, is shown according to an exemplary embodiment. Hard hat 10 includes an outer shell 12. In a specific embodiment, outer shell 12 is formed from a rigid material, such as a rigid polymer material. In various specific embodiments, outer shell 12 is formed from one of high-density polyethylene (HDPE), acrylonitrile-butadine-styrene (ABS), polycarbonate (PC), polycarbonate/acrylonitrile-butadine-styrene (PC-ABS), and polypropylene (PP). Outer shell 12 includes an exterior surface 14 and an interior surface 16. Interior surface 16 defines a cavity 18 (see e.g., FIG. 7) sized to receive a head 21 of a user and/or wearer 20. Outer shell 12 includes a crown portion 22 and a bottom segment 24 defining a lower circumference of hard hat 10.

As will be generally understood, a front brim present on the front of a conventional hard hats generally does not allow for appropriate positioning of accessories such as AR/VR goggles. In various embodiments, hard hat 10 does not include a front brim extending radially outward from the front of shell 12 to allow for appropriate positioning of AR/VR goggles. In various embodiments, a lip 26 extends radially outward from a portion of the lower circumference. In a specific embodiment, lip 26 extends radially outward from the front 28 of hard hat 10 and specifically outer shell 12. In various embodiments, lip 26 extends from bottom segment to define the outermost, forward extension of the shell 12. In a specific embodiment, lip 26 extends a distance between 0 and 3 mm. In various specific embodiments, lip 26 extends less than 7 mm, specifically less than 5 mm, and more specifically 3 mm or less from the front surface of hard hat 10. This is in contrast to conventional Type II no-brim helmets that frequently still have an extension or lip between 8 to 11 mm in length.

Various embodiments of a hard hat 10 configured to support AR/VR goggles 46 (e.g., Microsoft Hololens 2) and associated components (e.g., battery pack 48, wiring 54, etc.) are shown. The hard hat 10 is designed to support the AR/VR goggles 46 and associated components while maintaining the protection functionality of the hard hat 10 and providing a balanced, comfortable and easy to wear AR/VR equipped hard hat 10.

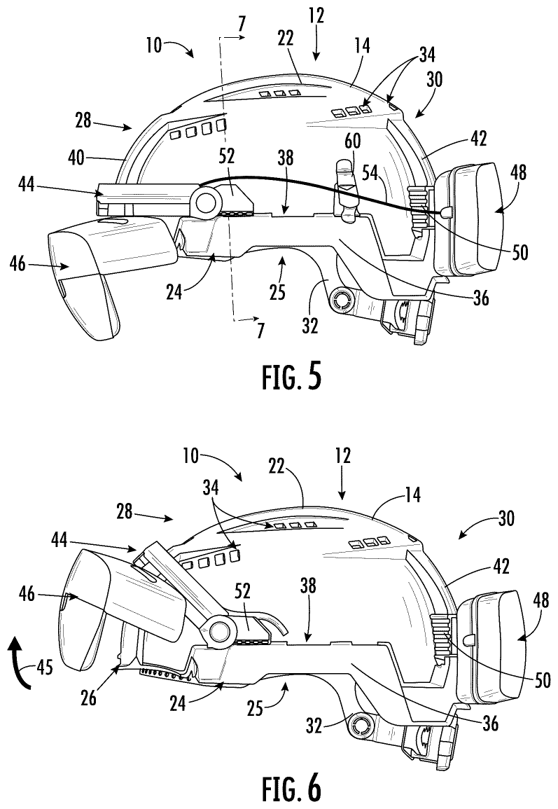

A mounting or accessory bracket, shown as hinged mounting bracket 44 is couplable to hard hat 10 and AR/VR goggles 46. One or more clips, shown as mounting clips 52 are coupled to hinged mounting bracket 44. As will be discussed in greater detail below, hinged mounting bracket 44 allows for the movement of AR/VR goggles 46 between an in use or active position (see e.g., FIGS. 1 and 5) and a storage or not in use position (see e.g., FIG. 6).

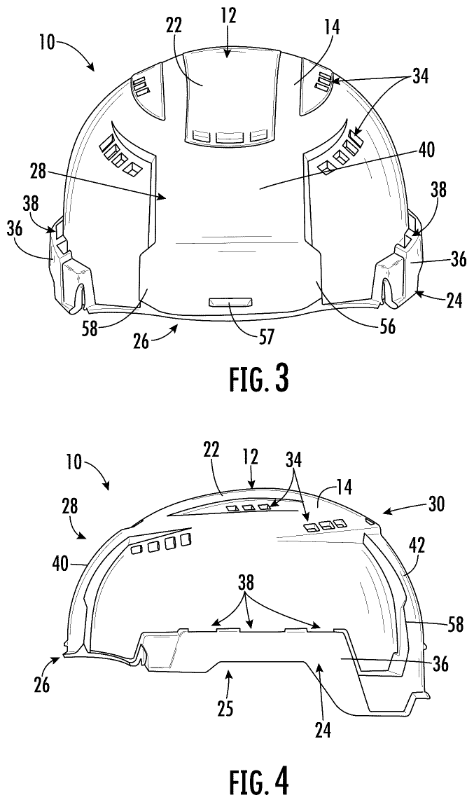

Referring to FIGS. 3-6, hard hat 10 includes a suspension system 32 to support and secure hard hat 10 to the wearer's 20 head 21. Outer shell 12 further includes a plurality of apertures or vents 34. Vents 34 extend through outer shell 12 providing fluid communication between cavity 18 and the ambient air proximate to exterior surface 14 of outer shell 12. Outer shell 12 further includes recess 25 positioned between front 28 and rear 30 (see e.g., FIG. 2) of hard hat 10 proximate to the cars of wearer 20. In a specific embodiment, recess 25 extends a height above a portion of bottom segment 24 proximate to front 28 and/or rear 30 of hard hat 10.

As will be discussed in greater detail below, various embodiments include one or more mounting ridges configured to couple to and/or support hard hat accessories. A side accessory support ridge or auxiliary mounting ridge 36 is coupled to a lateral side of outer shell 12 along the bottom segment 24. Auxiliary mounting ridge 36 includes a first end and a second end opposing the first end. A plurality of apertures or slots 38 are positioned along auxiliary mounting ridge 36 between the first end and the second end. In a specific embodiment, auxiliary mounting ridge 36 includes three slots.

In other embodiments, auxiliary mounting ridge 36 includes a different number of slots 38 (e.g., 1, 2, 4, 5, 6, etc.). Slots 38 are configured to receive a coupling mechanism, such as clips, or a portion of a hard hat accessory to couple the accessory to outer shell 12. Auxiliary mounting ridge 36 supports accessories for hard hat 10, such as hinged bracket arm, AR/VR goggles, earmuffs, tool or eyeglass holders, lamp supports, face shields, and/or reflectors, etc. In a specific embodiment, a clip 52 are couplable to hinged mounting bracket 44 and can be positioned within a slot 38 such that hinged mounting bracket 44 and/or AR/VR goggles 46 are supported from auxiliary mounting ridge 36. In various embodiments, further accessory supports such as accessory clip 60 are used with hard hat 10 and AR/VR goggles 46. In a specific embodiment, accessory clip 60 is positioned in a slot 38 and configured to support and/or retain a wire 54 of the AR/VR goggles 46 that extends between the AR/VR goggles 46 and battery pack 48.

In various embodiments, an additional side accessory support ridge or auxiliary mounting ridge 36 is coupled to a lateral side of outer shell 12 along the bottom segment 24. In a specific embodiment, a pair of clips 52 are coupled to hinged mounting bracket 44 and can be positioned within a slot 38 on each of the auxiliary mounting ridge 36 such that hinged mounting bracket 44 and/or AR/VR goggles 46 are supported from both auxiliary mounting ridges 36. Hard hat 10 further includes a front mounting ridge 40 positioned on the front 28 of outer shell 12. Front mounting ridge 40 includes a first or right edge 56 protruding outwardly from the front mounting ridge 40 and a second or left edge 58 opposing the right edge 56 and protruding outwardly from the front mounting ridge 40. In a specific embodiment, front mounting ridge 40 includes a detent 57 (see e.g., FIG. 3) positioned between the right edge 56 and the left edge 58 and configured to interface with an accessory mounting bracket (see e.g., hinged bracket arm 44) and/or an accessory. The right edge 56 and left edge 58 of the front mounting ridge 40 each extend toward the bottom segment 24 of the outer shell 12. The right edge 56 and left edge 58 each include a portion with an increased width as the right edge 56 and left edge 58 approach the bottom segment 24 and/or the lip 26.

In various embodiments, the hard hat 10 includes a second or rear mounting ridge 42 located along at the rear 30 of the hard hat 10. This allows a user to attach accessories and/or mounting brackets such as accessory bracket 50 to both the front 28 and rear 30 of hard hat 10. Rear mounting ridge 42 is substantially the same as front mounting ridge 40. Rear mounting ridge 44 includes a first or right edge 56 protruding outwardly from the rear mounting ridge 42 and a second or left edge 58 opposing the right edge 56 and protruding outwardly from the rear mounting ridge 42. In various embodiments, as accessory bracket 50 is configured to couple and support battery pack 48 that provides power to AR/VR goggles 46.

Referring to FIGS. 5-6, pivoting movement of AR/VR goggles 46 is shown according to an exemplary embodiment. The pivoting movement of AR/VR goggles 46 in an upward direction (e.g., toward crown 22 of hard hat 10) is shown by arrow 45. FIG. 5 shows AR/VR goggles 46 in a first, active position where AR/VR goggles 46 are positioned in front of the wearer's 20 eyes. FIG. 6 shows AR/VR goggles 46 in a second, storage position where AR/VR goggles 46 are positioned above the wearer's 20 eyes and generally in line with hard hat 10 shell 12. In the storage position, AR/VR goggles 46 are positioned relatively close to the exterior surface 14 of the hard hat 10. In such a position, Applicant believes the hard hat 10 remains balanced and comfortable to wear, while limiting the chance that the AR/VR goggles 46 impact or snag on the environment surrounding the user. Applicant believes the designs discussed herein allow for a decrease in distance between the AR/VR goggles in the storage position and the helmet of up to 50%.

Referring to FIG. 7, a cross-sectional view of the hard hat 10 is shown according to an exemplary embodiment. Specifically, the coupling between hinged mounting bracket 44 and helmet 10 and/or auxiliary mounting ridges 36 is shown. Hinged bracket 44 and specifically bracket arm 62 includes a hinge 76 positioned at each end. In a specific embodiment, the hinge 76 is a 45 degree hinge. In various specific embodiments, hinge 76 is lockable in both the active position (e.g., at zero degrees) and the storage position (e.g., at 45 degrees) such that the AR/VR goggles 46 are held or secured in the chosen position.

A clip 52 is coupled to the hinges 76 of hinged bracket 44. Clip 52 is positioned within slots 38 in opposing auxiliary ridges 36. A downward facing surface 53 of the outer shell 12 and specifically a wall portion 55 of outer shell 12 positioned behind (i.e., defines rear wall of slots 38) auxiliary mounting ridge 36 engages clip 52. As will be discussed in greater detail below, a support surface 88 of clip 52 engages wall portion 55 and/or downward facing surface 53 of shell 12 such that clip 52 is supported by auxiliary mounting ridge 36.

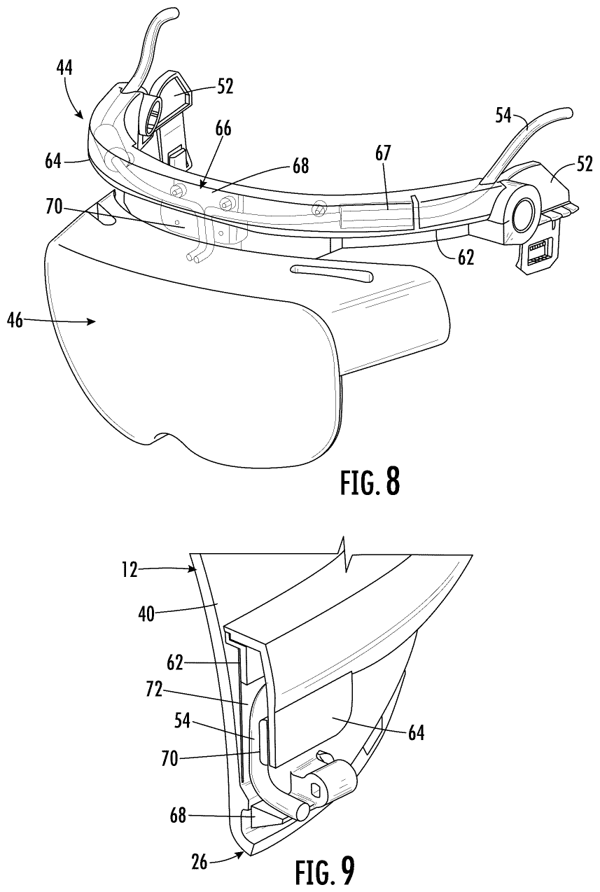

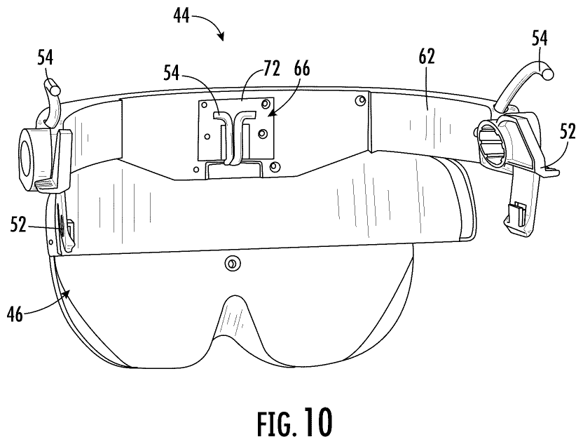

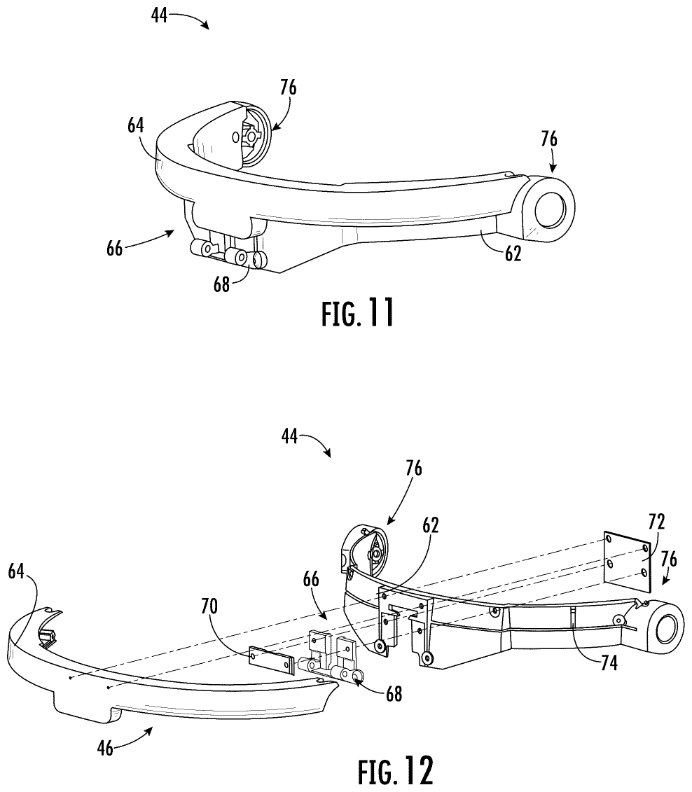

Referring to FIGS. 8-14, details of the hinged mounting bracket 44 and the coupling with AR/VR goggles 46 are shown. As shown in FIGS. 8 and 11, hinged mounting bracket 44 includes a bracket arm 62, a cover 64, and a hinge assembly 66. Hinged mounting bracket 44 and hinge assembly are coupled by a plurality of fasteners (e.g., screws, etc.). Bracket arm 62 includes opposing ends that each have a hinge 76 that allows for engagement of opposing auxiliary mounting ridges or ports/slots 38 on the opposing lateral sides of hard hat 10.

As can be seen in FIGS. 5-6, when AR/VR goggles 46 are pivoted toward the storage position, mounting bracket 44 moves generally upward along exterior surface 14 of shell 12 and around front mounting ridge 40 toward the crown 22 of hard hat 10. Similarly, when AR/VR goggles 46 are pivoted toward the active or in use position, mounting bracket 44 moves generally downward along exterior surface 14 of shell 12 and around front mounting ridge 40 toward the bottom segment 24 of hard hat 10.

Hinge assembly 66 includes a tilting mounting hinge 68 and a face plate 70 coupled to tilting mounting hinge 68. Tilting mounting hinge 68 is coupled to bracket arm 62 and allows for angular movement of the AR/VR goggles 46 relative to hard hat 10 and/or mounting bracket 44. In various embodiments, tilting mounting hinge 68 is coupled to bracket arm 62 between the opposing ends or hinges 76. In a specific embodiment, tilting mounting hinge 68 is coupled to the center of bracket arm 62. In a specific embodiment, tilting mounting hinge 68 is coupled to a front surface of bracket arm 62 and positioned in the center of bracket arm 62 between opposing hinges 76.

In specific embodiments, tilting mounting hinge 68 allows for angular movement of the AR/VR goggles 46 up to 45 degrees relative to hard hat 10 and/or mounting bracket 44. In other words, tilting mounting hinge 68 allows for movement between 0 and 45 degrees. In various specific embodiments, tilting mounting hinge 68 allows for angular movement of AR/VR googles 46 up to 45 degrees relative to the front surface of bracket arm 62 and/or a plane defined by the front surface of bracket arm 62. In various specific embodiments, tilting mounting hinge 68 allows for angular movement of AR/VR googles 46 up to 45 degrees relative to the front, center surface of bracket arm 62 and/or a plane defined by the front, center surface of bracket arm 62. In various specific embodiments, tilting mounting hinge 68 allows for angular movement of AR/VR googles 46 up to 45 degrees relative to the front surface of hard hat 10 and/or a plane defined by the front surface of hard hat 10 (e.g., front mounting ridge 40).

As shown in FIGS. 8-10, a wire extends from AR/VR goggles 46 and is routed around bracket arm 62 underneath cover 64 toward clips 52. In a specific embodiment, bracket arm 62 includes a strain relief feature 74 for wire 54. Specifically, strain relief feature 74 acts as a stop on the wire bundle 67 (see e.g., FIG. 8) that has a greater diameter than other portions of the wire 54. Strain relief feature 74 does not allow for the exposed portion of wire 54 to pull on the opposing end of the wire 54 connected to AR/VR goggles 46 internally.

Hinged mounting bracket 44 further includes a back plate 72 positioned behind bracket arm 62. In other words, back plate 72 is positioned between bracket arm 62 and hard hat 10. Back plate 72 provides further protection for wire 54 so that wire 54 is generally enclosed or surrounded by hinged mounting bracket 44 until the wire approaches hinge 76 and clip 52. The portion of wire 54 adjacent to hinge 76 of hinged mounting bracket 44 and/or clips 52 extends out from between bracket arm 62 and cover 64 and around the exterior surface 14 of hard hat 10 toward any accessory such as battery pack 48 that is connected to AR/VR goggles 46.

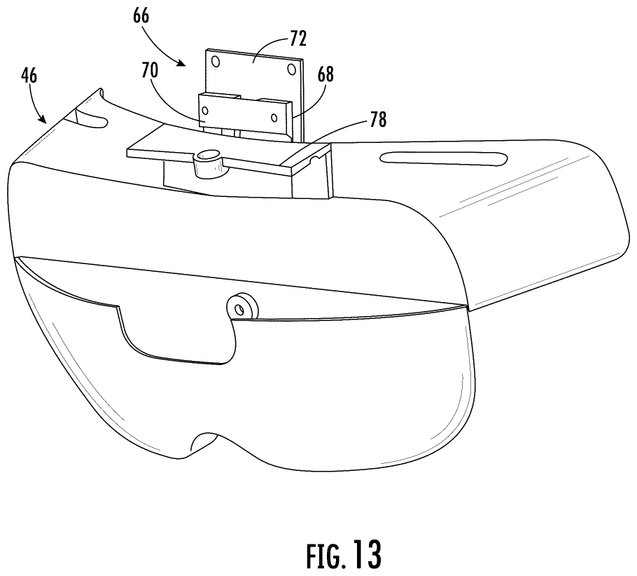

Referring to FIG. 13, connection between AR/VR goggles 46 and hinge assembly 66 is shown according to an exemplary embodiment. A connector 78 positioned along the rear of AR/VR goggles 46 is coupled to hinge assembly 66 to allow for the pivoting movement of AR/VR goggles 46. In a specific embodiment, connector 78 is positioned generally in the center of the AR/VR goggles 46.

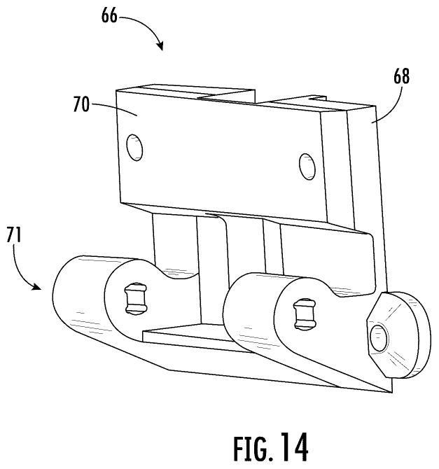

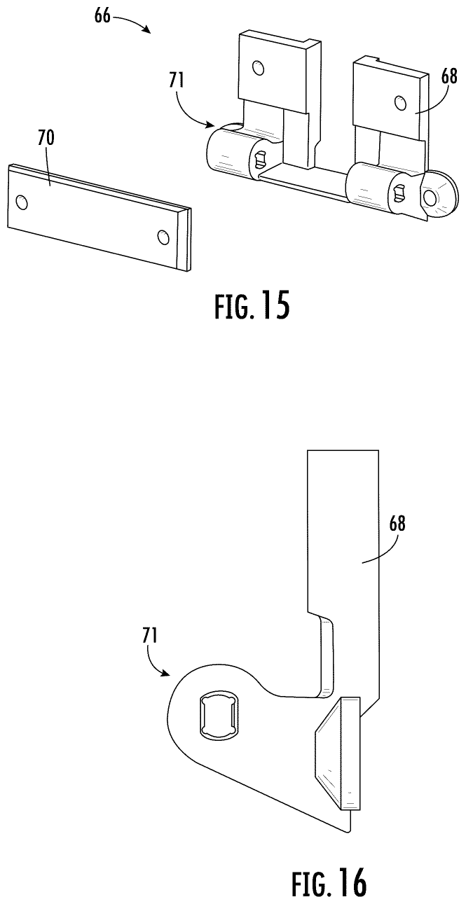

Referring to FIGS. 14-16, details of hinge assembly 66 are shown, according to an exemplary embodiment. Face plate 70 is coupled to an upper portion of tilting mounting hinge 68 by a fastener (e.g., screw, bolt, etc.). Tilting mounting hinge 68 includes an engagement portion 71 that couples to the AR/VR goggles 46 and allows for the movement or pivoting of AR/VR goggles 46. When hinge assembly 66 is assembled. The face plate 70 is coupled to tilting mounting hinge 68 above the engagement portion 71.

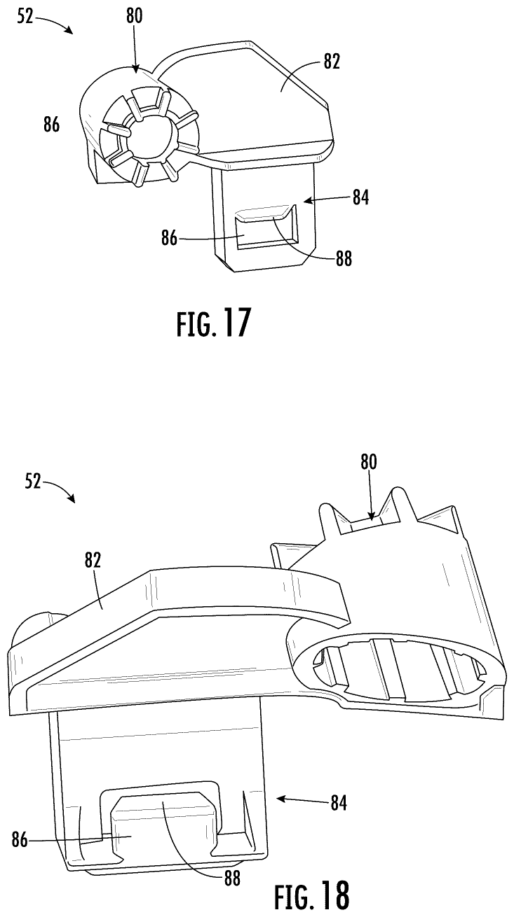

Referring to FIGS. 17-18, details of clip 52 are shown, according to an exemplary embodiment. Clip 52 includes a hinge portion 80 that corresponds and couples to one or more of the hinges 76 of hinged bracket 44. Clip 52 further includes a body 82 and an engagement portion 84. Body 82 is coupled to hinge portion 80 and engagement portion 84 and positioned between hinge portion 80 and engagement portion 84. Engagement portion 84 includes a tab 86 configured to engage hard hat 10 and specifically one of the slots 38. Coupling tab 86 includes a support surface 88 that is configured to engage hard hat 10. As shown in FIG. 7, support surface 88 of clip 52 engages wall portion 55 and/or downward facing surface 53 of shell 12 such that clip 52 is supported by auxiliary mounting ridge 36.

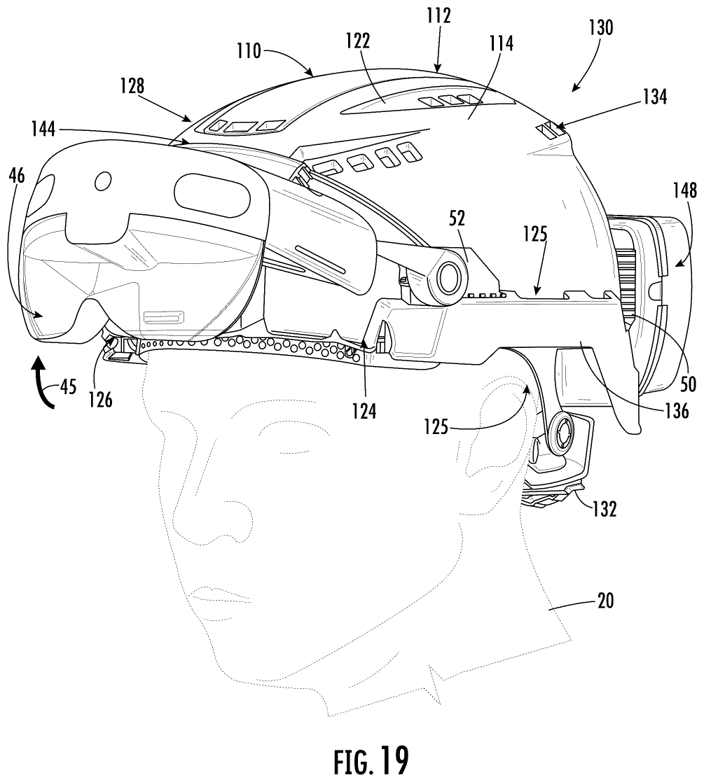

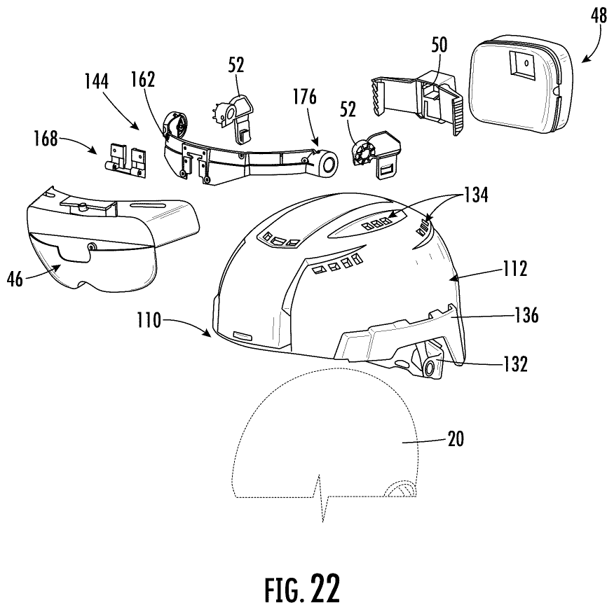

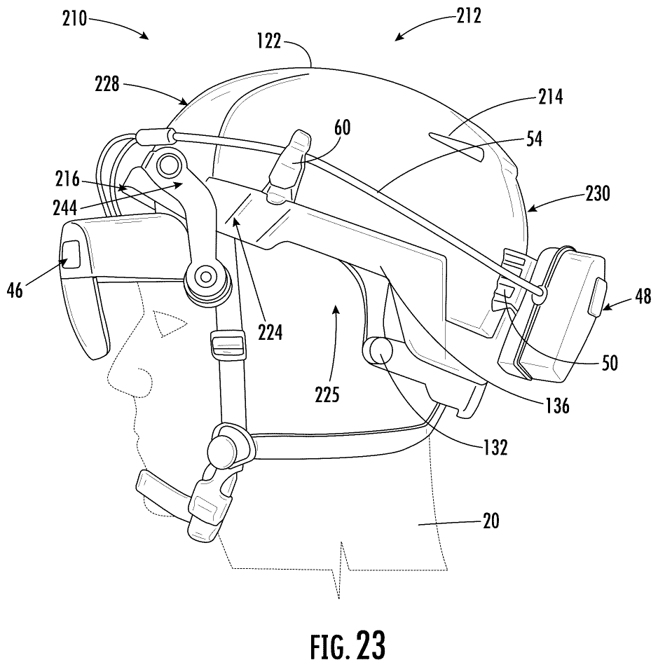

Referring to FIGS. 19-22, a hard hat 110 supporting AR/VR goggles 46 is shown according to another exemplary embodiment. Hard hat 110 is substantially the same as hard hat 10 except for the differences discussed herein. Hard hat 110 is configured to support AR/VR goggles 46 (e.g., Microsoft Hololens 2) and associated components (e.g., battery pack 48, wiring, etc.) and can be utilized AR/VR goggles 46.

Hinged mounting bracket 144 is substantially the same as hinged mounting bracket 44 except for the differences discussed herein. Bracket arm 162 includes hinges 176. In a specific embodiment, hinges 176 are 45 degree hinges. In a specific embodiment, hinges 176 are lockable such that hinged mounting bracket 144 and/or AR/VR goggles 46 can be secured or held in a desired position relative to hard hat 110.

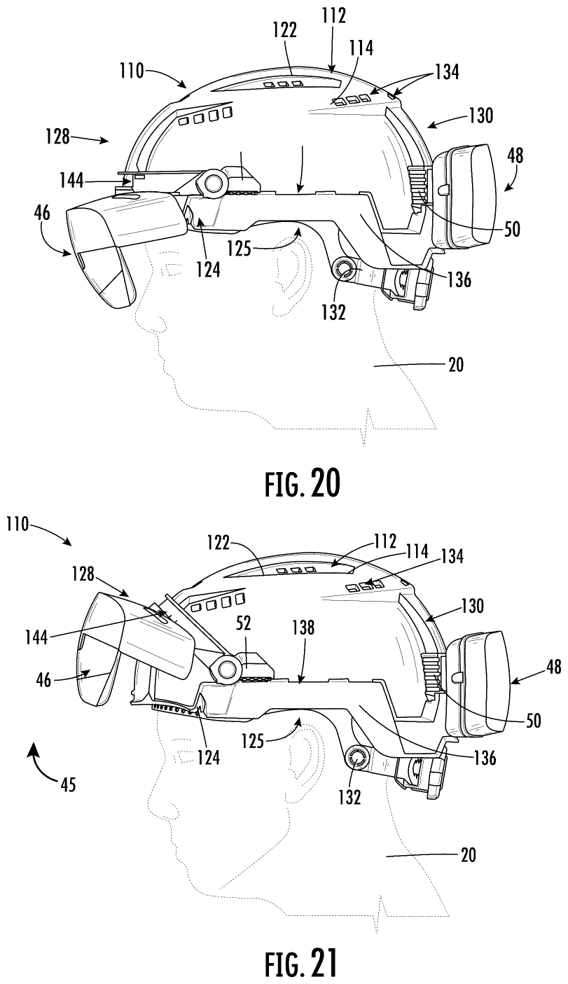

Referring to FIGS. 20-21, pivoting movement of AR/VR goggles 46 is shown according to an exemplary embodiment. The pivoting movement of AR/VR goggles 46 in an upward direction (e.g., toward crown 122 of hard hat 110) is shown by arrow 45. FIG. 20 shows AR/VR goggles 46 in a first, active position where AR/VR goggles 46 are positioned in front of the wearer's 20 eyes. FIG. 21 shows AR/VR goggles 46 in a second, storage position where AR/VR goggles 46 are positioned above the wearer's 20 eyes and generally in line with the shell 112 of hard hat 110.

Referring to FIG. 23, a hard hat 210 supporting AR/VR goggles 46 is shown according to another exemplary embodiment. Hard hat 210 is substantially the same as hard hats 10 and 110 except for the differences discussed herein. Hard hat 210 is configured to support AR/VR goggles 46 (e.g., Microsoft Hololens 2) and associated components (e.g., battery pack 48, wiring, etc.) and can be utilized AR/VR goggles 46. Hard hat 210 includes a brim 26. The hinged mounting bracket 244 is positioned on brim 26 during use while AR/VR goggles 46 are below brim 26. Such an arrangement is used when hard hat 210 is tilted relative to a standard hard hat position.

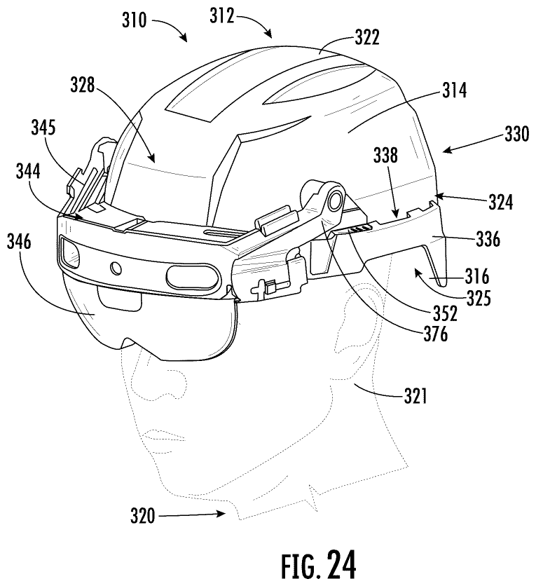

Referring to FIGS. 24-27, perspective views of a protective work or construction helmet, shown as hard hat 310, mounting bracket 344 and AR/VR goggles 346, are shown according to another exemplary embodiment. Hard hat 310 is substantially the same as hard hats 10, 110 and 210 except for the differences discussed herein. Hard hat 310 is configured to support AR/VR goggles 346 (e.g., Microsoft Hololens 2) and associated components (e.g., battery pack 348, wiring 354, etc.) and can be utilized AR/VR goggles 346.

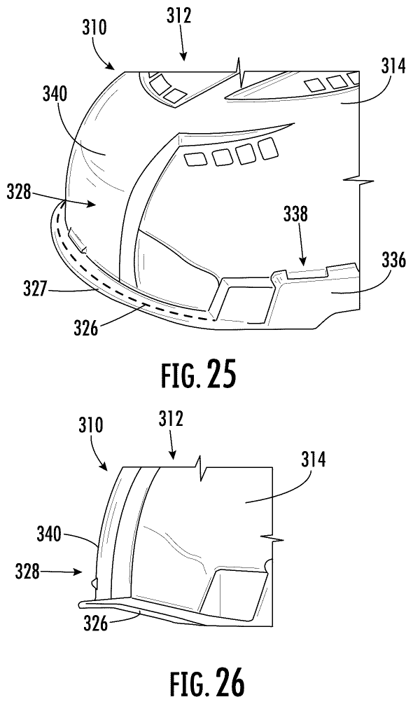

As will be generally understood, a front brim and/or a front mounting ridge present on the front of a conventional hard hats generally does not allow for appropriate positioning of accessories such as AR/VR goggles. In various embodiments, hard hat 310 does not include a front brim extending radially outward from the front of shell 312 to allow for appropriate positioning of AR/VR goggles. In various embodiments, a lip 326 extending radially outward from a portion of the lower circumference of shell 312 is reduced relative to conventional hard hats. As shown in FIG. 25, lip 326 extends a reduced distance compared to an extension of a lip 327 that extends further outward from hard hat 310.

In various embodiments, lip 326 extends from bottom segment to define the outermost, forward extension of the shell 312. In a specific embodiment, lip 326 extends a distance less than a maximum distance from the front surface of hard hat 310. This is in contrast to conventional Type II no-brim helmets that frequently still have an extension or lip between 8 to 11 mm in length.

As shown in FIG. 26, the size and/or extension of front mounting ridge 340 relative to shell 312 is limited. As previously noted, Applicant believes this profile of hard hat 310 along with mounting bracket 344 allows for accessories such as AR/VR goggles 346 to be used without a tilting hinge. In various embodiments, a front mounting ridge 340 extending outward from a crown 322 of the shell is reduced in size. In various specific embodiments, front mounting ridge 340 extends a distance less than a maximum distance from the front surface of hard hat 310.

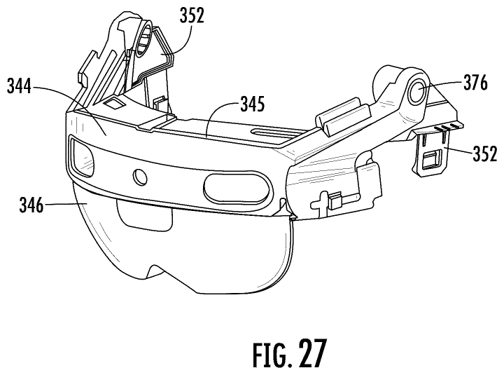

Referring to FIG. 27, details of mounting bracket 344 are shown, according to an exemplary embodiment. Mounting bracket 344 is substantially the same as hinged mounting brackets 44 and 144 except for the differences discussed herein. Mounting bracket 344 does not include a hinge assembly (e.g., hinge assembly 66). Instead, mounting bracket 344 receives and supports AR/VR goggles 346 such that mounting bracket 344 and AR/VR goggles 346 are moveable between an active and a storage position without tilting the AR/VR goggles 346.

Mounting bracket 344 includes a track 345 to enclose and/or protect wires from being pulled away from the AR/VR goggles 346. In various specific embodiments, track 345 includes guides and a snap track to protect a wire.

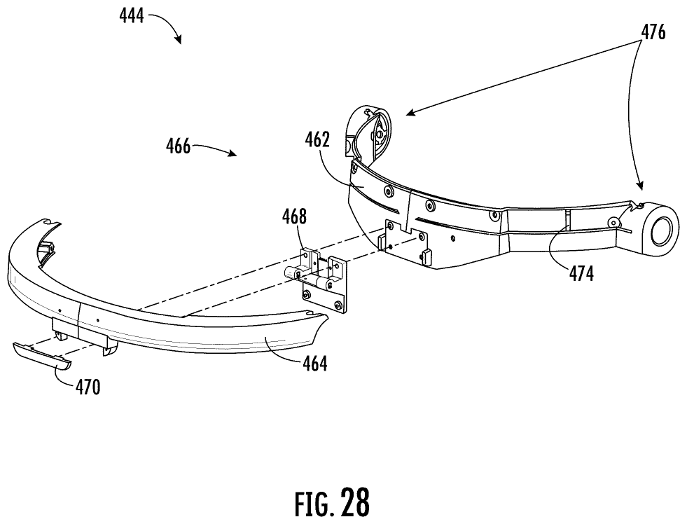

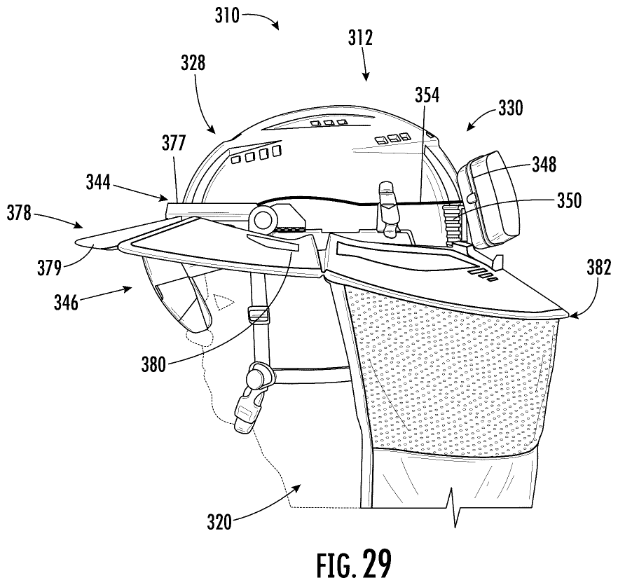

Referring to FIG. 28 details of a hinged mounting bracket 344 that can be utilized with or coupled to hard hat 10 and AR/VR goggles 46 is shown according to another exemplary embodiment. Hinge assembly 466 includes a tilting mounting hinge 468 and a face plate 470 coupled to tilting mounting hinge 468. Tilting mounting hinge 468 is coupled to a bracket arm 462 and allows for angular movement of the AR/VR goggles. In various embodiments, tilting mounting hinge 468 is coupled to bracket arm 462 between the opposing ends or hinges 476. In various specific embodiments, tilting mounting hinge 468 allows for angular movement of the AR/VR goggles up to 45 degrees.

In a specific embodiment, bracket arm 462 includes a strain relief feature 474 for a wire (see e.g., 54). Specifically, strain relief feature 474 acts as a stop on a wire bundle (see e.g., 67 in FIG. 8) that has a greater diameter than other portions of the wire. Strain relief feature 474 does not allow for the exposed portion of wire to pull on the opposing end of the wire connected to AR/VR goggles 46 internally. Bracket arm 462 includes a portion positioned between hinged assembly 466 and the hard hat. In other words, bracket arm 462 does not require a back plate.

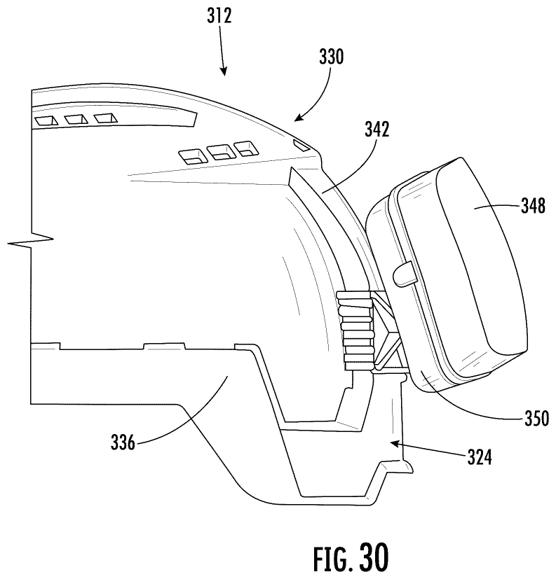

Referring to FIGS. 29-32, details of hard hat 310 supporting accessories is shown according to another exemplary embodiment. A mounting bracket, shown as accessory bracket 350 is configured to support and to couple to an accessory (e.g., battery pack 348, etc.) utilized with the AR/VR goggles 346 in a higher position relative to a bottom segment 324 of the hard hat 310 and/or a rear mounting ridge 342. In other words, a distance between battery pack 348 and bottom segment 324 in a vertical direction is increased compared to conventional accessory brackets.

Applicant has found accessory bracket 350 and the higher relative positioning of accessories coupled to accessory bracket 350 allows for simultaneous use with additional accessories such as a sun visor and/or sun shade. In a specific embodiment, a visor or sun visor 378 is coupled to hard hat 310. In various embodiments, mounting bracket 344 includes a ridge 377 positioned between opposing hinges 376. Ridge 377 engages visor 378 such that visor 378 is clipped below a portion of mounting bracket 344.

In various specific embodiments, visor 378 includes a front portion, shown as front brim segment 379, and a rear portion, shown as rear brim segment 386. In a specific embodiment, front brim segment 379 and rear brim segment 386 are interconnected such as by opposing stretch zones 380. In various embodiments, front brim segment 379 and rear brim segment 386 are separate components. In such an embodiment, rear brim segment 386 is coupled to accessory ridge 336 by a clip 384. In various embodiments, visor 378 includes a sun shade 382 that extends downward in a vertical direction, away from bottom segment 324 of hard hat 310. Sun shade 382 provides additional coverage and/or sun protection to a user's neck.

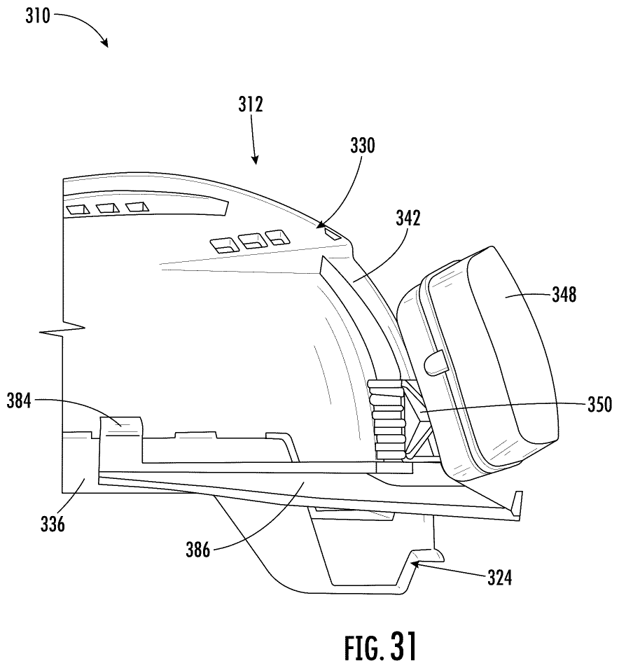

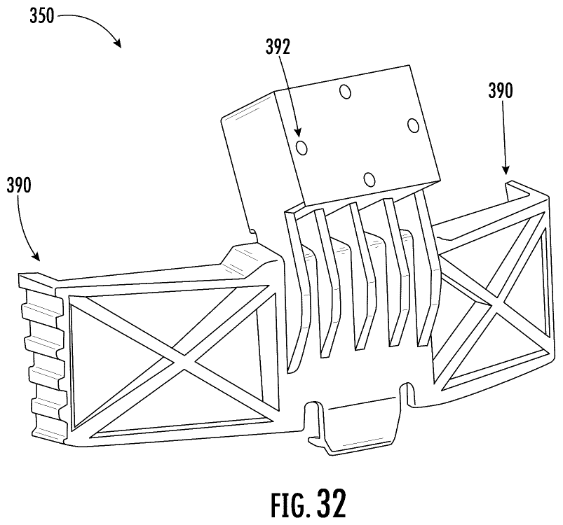

As shown in FIG. 31, when use of a visor 378 is desired, accessory bracket 350 can be coupled to hard hat 310 in a position above rear brim segment 386. In such an embodiment, the accessory (e.g., battery pack 348) is positioned above rear brim segment 386 in a vertical direction.

Referring to FIG. 32, details of accessory bracket 350 are shown according to an exemplary embodiment. Accessory bracket 350 includes opposing end portions 390 configured to couple to rear mounting ridge 342 and/or front mounting ridge 340. An engagement portion 392 is configured to engage and support an accessory. Engagement portion 392 extends further upwards in a vertical direction compared to opposing end portions 390. Engagement portion 392 extends outwards in a radial direction (e.g., away from rear mounting ridge 342) a greater distance than opposing end portions 390 of accessory bracket 350.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A safety headwear system comprising:
a hard hat comprising:
an outer shell comprising:
an exterior surface;
an interior surface defining a cavity configured to receive a head of an operator;
a crown portion, the crown portion configured to cover part of the head of the operator;
a bottom portion defines a lower circumference along the exterior surface of the outer shell; and
side mounting ridges positioned on opposing lateral sides of the bottom portion;
a mounting bracket comprising:
a bracket arm comprising opposing ends, each of the opposing ends comprising a hinge configured to engage the side mounting ridges of the hard hat; and
wherein the mounting bracket is configured to support a pair of AR/VR goggles.

2. The safety headwear system of claim 1, the mounting bracket further comprising a tilting mounting hinge positioned on the bracket arm between the hinges, the tilting mounting hinge is configured to support the pair of AR/VR goggles.

3. The safety headwear system of claim 2, wherein the tilting mounting hinge allows for angular movement of the pair of AR/VR goggles relative to the hard hat.

4. The safety headwear system of claim 3, wherein the angular movement of the pair of AR/VR goggles is between 0 and 45 degrees.

5. The safety headwear system of claim 1, the side mounting ridges further comprising a plurality of slots, the plurality of slots configured to receive and support the mounting bracket.

6. The safety headwear system of claim 1, the mounting bracket further comprising:
a guide positioned along a front surface of the bracket arm, the guide supporting a wire extending from the pair of AR/VR goggles; and
a cover coupled to the front surface of the bracket arm;
wherein the wire is positioned between the bracket arm and the cover.

7. The safety headwear system of claim 6, the mounting bracket further comprising a stop coupled to the front surface of the bracket arm, wherein the stop prevents movement of a portion of the wire relative to the mounting bracket.

8. The safety headwear system of claim 1, further comprising a pair of mounting clips, the mounting clips coupled to the opposing ends of the bracket arm.

9. The safety headwear system of claim 1, wherein the hard hat further comprises a brim extending outward from the lower circumference, and wherein the brim extends less than 7 mm from a front surface of the hard hat.

10. A mounting bracket for AR/VR goggles comprising:
a bracket arm comprising:
a first end;
a second end opposing the first end, the first end and the second end each comprise a hinge; and
a tilting mounting hinge positioned on the bracket arm between the first end and the second end, the tilting mounting hinge comprising a front engagement portion configured to couple to AR/VR goggles.

11. The mounting bracket of claim 10, wherein the tilting mounting hinge allows for angular movement of the AR/VR goggles relative to the bracket arm.

12. The mounting bracket of claim 10, further comprising a mounting clip coupled to the first end of the bracket arm, the mounting clip configured to engage a side mounting ridge on a hard hat such that the mounting bracket is supported by the hard hat.

13. The mounting bracket of claim 10, further comprising:
a guide positioned along a front surface of the bracket arm, the guide configured to support a wire extending from the AR/VR goggles; and
a cover coupled to the front surface of the bracket arm;
wherein the wire is positioned along the front surface of the bracket arm between the bracket arm and the cover.

14. The mounting bracket of claim 10, wherein the hinge is pivotable between an active position in which the tilting mounting hinge is not angled and a storage position in which the tilting mounting hinge is angled relative to the bracket arm.

15. A safety headwear system comprising:
a hard hat comprising:
an outer shell comprising:
an exterior surface;
an interior surface defining a cavity configured to receive a head of an operator;
a crown portion comprising a front side and a rear side, the crown portion configured to cover part of the head of the operator;
a bottom portion defines a lower circumference along the exterior surface of the outer shell;
a front mounting ridge on the front side of the outer shell; and
side mounting ridges positioned on opposing lateral sides of the bottom portion;
a mounting bracket that removably couples to the hard hat, the mounting bracket comprising:
a first end;
a second end opposing the first end, the first end and the second end each comprise a hinge;
wherein the mounting bracket is configured to support AR/VR goggles, such that the AR/VR goggles are moveable relative to the hard hat between an active position and a storage position.

16. The safety headwear system of claim 15, wherein, when the AR/VR goggles are in the active position, the AR/VR goggles are positioned in front of a lower front edge of the hard hat.

17. The safety headwear system of claim 15, wherein, when the AR/VR goggles are in the storage position, the AR/VR goggles are positioned above a lower front edge of the hard hat.

18. The safety headwear system of claim 16, wherein the lower front edge of the hard hat defines a brim and wherein the brim extends outward less than 7 mm from a front surface of the hard hat.

19. The safety headwear system of claim 16, wherein the mounting bracket further comprises a tilting mounting hinge positioned between the first end and the second end, the tilting mounting hinge comprising a front engagement portion removably couplable to AR/VR goggles, wherein the tilting mounting hinge allows for angular movement of the AR/VR goggles relative to the hard hat.

20. The safety headwear system of claim 16, further comprising:
a first mounting clip coupled to the first end; and
a second mounting clip coupled to the second end;
wherein the first mounting clip and the second mounting clip engage with the side mounting ridges of the hard hat such that the mounting bracket is supported by the hard hat.
